(19) United States
(12) Patent Application Publication
(10) Pub. No.: US 2019/0255692 A1
(43) Pub. Date: Aug. 22, 2019

(54) CUTTING TOOL FOR USE WITH A HAMMER DRILL

(71) Applicant: Jerome Jablonski, Ashley, IL (US)

(72) Inventor: Jerome Jablonski, Ashley, IL (US)

(21) Appl. No.: 15/898,519

(22) Filed: Feb. 17, 2018

(51) Int. Cl. B25D 17/00; B26D 7/08; B25F 1/00

(52) U.S. Cl. CPC B25D 17/005; B25F 1/006; B26D 7/08

(57) ABSTRACT

A cutting tool for use with a hammer drill is a cutting tool that splits a Sonotube® by inserting it between the inner surface of the Sonotube® and the outer surface of the concrete pillar and driving it vertically downward using a hammer drill. The Sonotube® is easily split and removed from the pillar without risk of injury.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of power tool bits and more specifically relates to a cutting tool for use with a hammer drill.

### 2. Description of the Related Art

In the construction industry, concrete piers are often used to support elevated building structures instead of filling and compacting the foundation area with dirt, which can be expensive. Sometimes, concrete piers are used and material is filled around the piers and compacted when additional stability is required. The concrete piers are typically cylindrical in shape and forms used to make them are sturdy cardboard tubes or cylinders called Sonotube®s. The wet concrete is poured into the Sonotube® and once the concrete sets up, the Sonotube® needs to be cut away from the concrete pillar. Many different methods of Sonotube® removal are employed but each method has an inherent lack of safety since there is no special tool designed specifically for this job. A solution is needed.

Ideally, a Sonotube® removal tool should provide safety and ease of use, and yet, would operate reliably and be manufactured at a modest expense. Thus, a need exists for a reliable cutting tool for use with a hammer drill to avoid the above-mentioned problems.

### BRIEF SUMMARY OF THE INVENTION

In view of the foregoing disadvantages inherent in the known power tool bit art, the present invention provides a novel cutting tool for use with a hammer drill. The general purpose of the present invention, which will be described subsequently in greater detail, is to provide safety and ease of use when removing Sonotubes® from concrete pillars.

A cutting tool for use with a hammer drill may comprise an elongated shaft portion including a proximal end adapted to be releasably and securely held by a releasable attachment portion of a hammer drill, a distal end opposite the proximal end, and an axis extending between the proximal end and the distal end. A slide plate is attached to the distal end of the elongated shaft portion and has a curved cross-section adapted to be substantially similar to the cross-section of a chosen cylindrical concrete form. The inner surface is adapted to contact the outer surface of the cylindrical concrete column when in use, and the outer surface is adapted to contact the inner surface of the chosen cylindrical concrete form surrounding the cylindrical concrete column when in use.

An elongated knife blade is attached to the outer surface of the slide plate, and is oriented in a parallel direction to the axis of the elongated shaft portion. The cutting tool is adapted to be used to cut cylindrical concrete forms when in use such that the cylindrical concrete form can be peeled away from a formed concrete column. The elongated knife blade is attached to the outer surface of the slide plate at a 90 degree angle. The slide plate is attached to the distal end of the elongated shaft portion at an angle of between 5 degrees and 30 degrees.

The slide plate includes a proximal edge portion attached to the distal end of the elongated shaft portion, and a beveled distal edge portion located opposite the proximal edge portion and adapted to wedge between the cylindrical concrete form and the formed concrete column when in use. The elongated knife blade has a length extending in a direction co-linear with the axis of the elongated shaft portion. The knife blade extends from the beveled distal edge portion and has a height increasing along the length from the beveled distal edge portion to the proximal edge portion. The knife blade extends past the proximal edge portion and is further attached along a length of the elongated shaft portion. The cutting tool is formed from a material chosen from a list of materials consisting of iron, steel, rolled steel, hardened steel, and ceramic.

A cutting tool assembly for use upon a cylindrical concrete form may comprise a hammer drill which may be either operated by AC power supply or by DC rechargeable batteries, and including a releasable attachment portion that is adapted to releasably and securely hold a cutting tool. The hammer drill is adapted to provide repetitive linear movement to an attached cutting tool that has an elongated shaft portion including a proximal end adapted to be releasably and securely held by the releasable attachment portion of the hammer drill, a distal end opposite the proximal end, an axis extending between the proximal end and the distal end, and a slide plate. The slide plate is attached to the distal end of the elongated shaft portion.

The slide plate has a curved cross-section adapted to be substantially similar to a cross-section of a chosen cylindrical concrete form inner surface and is adapted to contact an outer surface of a cylindrical concrete column when in use, and an outer surface adapted to contact an inner surface of the chosen cylindrical concrete form surrounding the cylindrical concrete column when in use. An elongated knife blade is attached to the outer surface of the slide plate, and is oriented in a parallel direction to the axis of the elongated shaft portion.

The cutting tool assembly is adapted to be used to cut the cylindrical concrete form when in use such that the cylindrical concrete form can be peeled away from a formed concrete column. The elongated knife blade is attached to the outer surface of the slide plate at a 90 degree angle. The slide plate is attached to the distal end of the elongated shaft portion at an angle of between 5 degrees and 30 degrees. The slide plate includes a proximal edge portion attached to the distal end of the elongated shaft portion, and a beveled distal edge portion located opposite the proximal edge portion and adapted to wedge between the cylindrical concrete form and the formed concrete column when in use. The elongated knife blade has a length extending in a direction co-linear with the axis of the elongated shaft portion. The knife blade extends from the beveled distal edge portion. The elongated knife blade has a height increasing along the length from the beveled distal edge portion to the proximal edge portion and extends past the proximal edge portion and is further attached along a length of the elongated shaft portion. The cutting tool is formed from a material chosen from a list of materials consisting of iron, steel, rolled steel, hardened steel, and ceramic. The hammer drill is preferably an electric hammer drill and is battery operated.

The present invention holds significant improvements and serves as a cutting tool for use with a hammer drill. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a cutting tool for use with a hammer drill, constructed and operative according to the teachings of the present invention.

FIG. 1 shows a perspective view illustrating an in-use condition of a cutting tool for use with a hammer drill according to an embodiment of the present invention.

FIG. 2 is a perspective view illustrating the cutting tool for use with a hammer drill according to an embodiment of the present invention of FIG. 1.

FIG. 3 is a front elevation view illustrating the cutting tool for use with a hammer drill according to an embodiment of the present invention of FIG. 1.

FIG. 4 is an end view illustrating the cutting tool for use with a hammer drill according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a power tool bit and more particularly to a cutting tool for use with a hammer drill as used to improve the safety and ease of use when removing Sonotubes® from concrete pillars.

Generally speaking, a cutting tool for use with a hammer drill is a cutting tool that splits a Sonotubes® by inserting it between the inner surface of the Sonotubes® and the outer surface of the concrete pillar and driving it vertically downward using a hammer drill. The Sonotubes® is easily split and removed from the pillar without risk of injury.

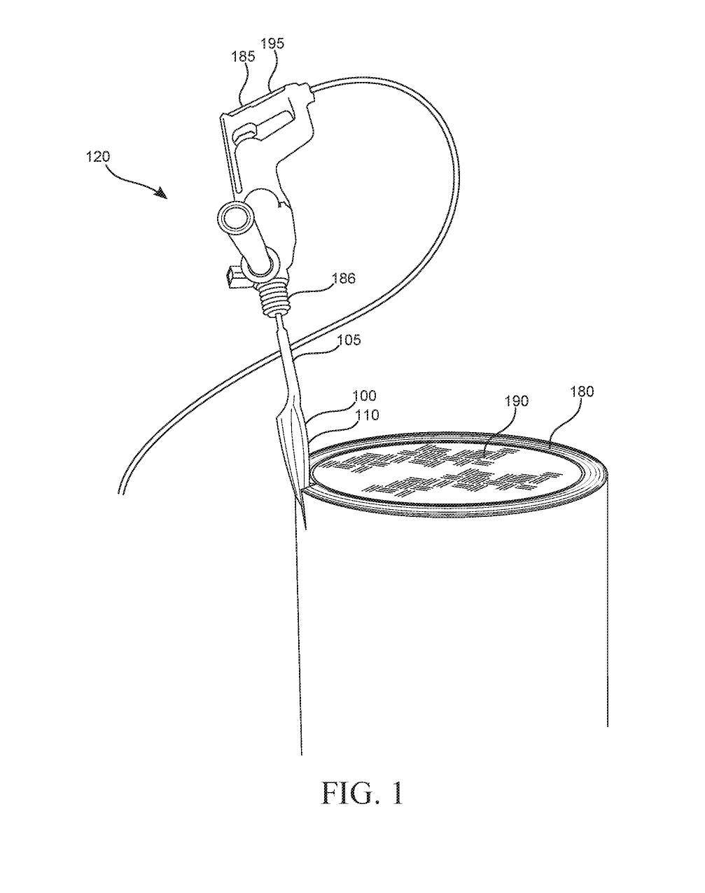

Referring to the drawings by numerals of reference there is shown in FIG. 1, a perspective view illustrating an in-use condition of cutting tool 100 for use with hammer drill 185 according to an embodiment of the present invention.

Cutting tool 100 for use with hammer drill 185 may comprise an elongated shaft portion 105 including proximal end 106 adapted to be releasably and securely held by releasable attachment portion 186 of hammer drill 185, distal end 107 opposite proximal end 106, and axis 108 extending between proximal end 106 and distal end 107. Slide plate 110 is attached to distal end 107 of the elongated shaft portion 105 and has curved cross-section 111 adapted to be substantially similar to the cross-section of a chosen cylindrical concrete form 180. Inner surface 112 is adapted to contact outer surface 113 of the cylindrical concrete column 190 when in use, and outer surface 113 is adapted to contact inner surface 112 of the chosen cylindrical concrete form 180 surrounding the cylindrical concrete column 190 when in use.

Cutting tool assembly 120 for use upon cylindrical concrete form 180 may comprise hammer drill 185 which may be either operated by AC power supply or by DC rechargeable batteries, including releasable attachment portion 186 that is adapted to releasably and securely hold cutting tool 100. Hammer drill 185 is adapted to provide repetitive linear movement to an attached cutting tool 100 that has an elongated shaft portion 105 including proximal end 106 adapted to be releasably and securely held by releasable attachment portion 186 of hammer drill 185, distal end 107 opposite proximal end 106, axis 108 extending between proximal end 106 and distal end 107, and slide plate 110. Slide plate 110 is attached to distal end 107 of the elongated shaft portion 105.

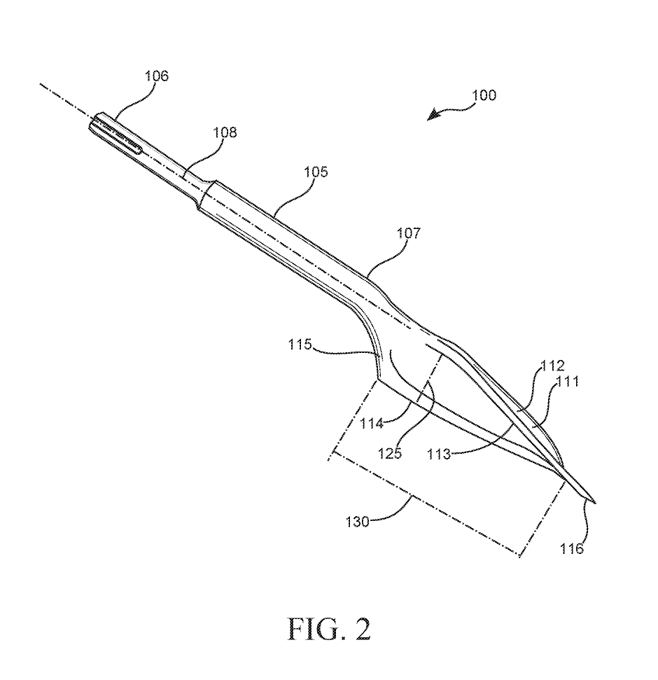

Referring now to FIG. 2, a perspective view illustrating cutting tool 100 for use with hammer drill 185 according to an embodiment of the present invention of FIG. 1.

An elongated knife blade 114 is attached to outer surface 113 of slide plate 110, and is oriented in a parallel direction to axis 108 of the elongated shaft portion 105. Cutting tool 100 is adapted to be used to cut cylindrical concrete forms 180 when in use such that cylindrical concrete form 180 can be peeled away from a formed concrete column 190. The elongated knife blade 114 is attached to outer surface 113 of slide plate 110 at a 90 degree angle. Slide plate 110 is attached to distal end 107 of the elongated shaft portion 105 at an angle of between 5 degrees and 30 degrees.

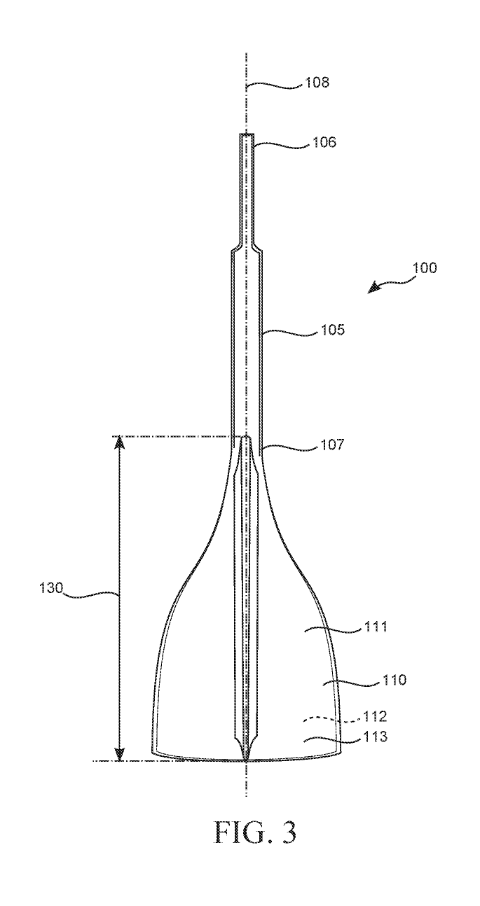

Referring now to FIG. 3, is a front elevation view illustrating cutting tool 100 for use with hammer drill 185 according to an embodiment of the present invention of FIG. 1.

Slide plate 110 includes proximal edge portion 115 attached to distal end 107 of the elongated shaft portion 105, and beveled distal edge portion 116 located opposite proximal edge portion 115 and adapted to wedge between cylindrical concrete form 180 and the formed concrete column 190 when in use. The elongated knife blade 114 has a length extending in a direction co-linear with axis 108 of the elongated shaft portion 105. Knife blade 114 extends from beveled distal edge portion 116 and has height 125 increasing along length 130 from beveled distal edge portion 116 to proximal edge portion 115. Knife blade 114 extends past proximal edge portion 115 and is further attached along a length of the elongated shaft portion 105. Cutting tool 100 is formed from a material chosen from a list of materials consisting of iron, steel, rolled steel, hardened steel, and ceramic.

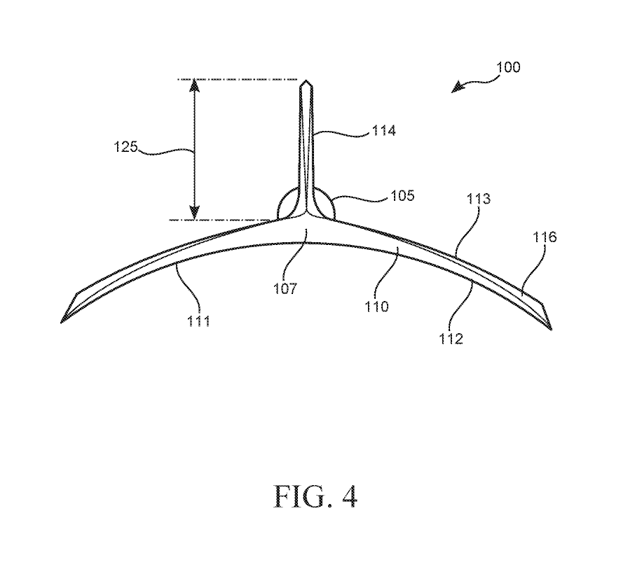

Referring now to FIG. 4, showing an end view illustrating cutting tool 100 for use with hammer drill 185 according to an embodiment of the present invention of FIG. 1.

Slide plate 110 has curved cross-section 111 adapted to be substantially similar to a cross-section of a chosen cylindrical concrete form 180 inner surface 112 and is adapted to contact outer surface 113 of a cylindrical concrete column 190 when in use, and outer surface 113 adapted to contact inner surface 112 of the chosen cylindrical concrete form 180 surrounding the cylindrical concrete column 190 when in use. An elongated knife blade 114 is attached to outer surface 113 of slide plate 110, and is oriented in a parallel direction to axis 108 of the elongated shaft portion 105.

Cutting tool assembly 120 is adapted to be used to cut cylindrical concrete form 180 when in use such that cylindrical concrete form 180 can be peeled away from a formed concrete column 190. The elongated knife blade 114 is attached to outer surface 113 of slide plate 110 at a 90 degree angle. Slide plate 110 is attached to distal end 107 of the elongated shaft portion 105 at an angle of between 5 degrees and 30 degrees. Slide plate 110 includes proximal edge portion 115 attached to distal end 107 of the elongated shaft portion 105, and beveled distal edge portion 116 located opposite proximal edge portion 115 and adapted to wedge between cylindrical concrete form 180 and the formed concrete column 190 when in use. The elongated knife blade 114 has a length extending in a direction co-linear with axis 108 of the elongated shaft portion 105. Knife blade 114 extends from beveled distal edge portion 116. The elongated knife blade 114 has height 125 increasing along length 130 from beveled distal edge portion 116 to proximal edge portion 115 and extends past proximal edge portion 115 and is further attached along a length of the elongated shaft portion 105. Cutting tool 100 is formed from a material chosen from a list of materials consisting of iron, steel, rolled steel, hardened steel, and ceramic. Hammer drill 185 is preferably electric hammer drill 195 and is battery operated.

Cutting tool assembly 120 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A cutting tool for use with a hammer drill, comprising:
an elongated shaft portion including;
a proximal end adapted to be releasably and securely held by a releasable attachment portion of a hammer drill;
a distal end opposite said proximal end; and
an axis extending between said proximal end and said distal end;
a slide plate;
wherein said slide plate is attached to said distal end of said elongated shaft portion;
wherein said slide plate has a curved cross-section adapted to be substantially similar to a cross-section of a chosen cylindrical concrete form;
an inner surface adapted to contact an outer surface of a cylindrical concrete column when in use; and
an outer surface adapted to contact an inner surface of said chosen cylindrical concrete form surrounding said cylindrical concrete column when in use; and
an elongated knife blade;
wherein said elongated knife blade is attached to said outer surface of said slide plate, and is oriented in a parallel direction to said axis of said elongated shaft portion;
wherein said cutting tool is adapted to be used to cut cylindrical concrete forms when in use such that said cylindrical concrete form can be peeled away from a formed concrete column.

2. The cutting tool of claim 1, wherein said elongated knife blade is attached to said outer surface of said slide plate at a 90 degree angle.

3. The cutting tool of claim 1, wherein said slide plate is attached to said distal end of said elongated shaft portion at an angle of between 5 degrees and 30 degrees.

4. The cutting tool of claim 1, wherein said slide plate includes a proximal edge portion attached to said distal end of said elongated shaft portion, and a beveled distal edge portion located opposite said proximal edge portion and adapted to wedge between said cylindrical concrete form and said formed concrete column when in use.

5. The cutting tool of claim 4, wherein said elongated knife blade has a length extending in a direction co-linear with said axis of said elongated shaft portion; wherein said knife blade extends from said beveled distal edge portion; and wherein said elongated knife blade has a height increasing along said length from said beveled distal edge portion to said proximal edge portion.

6. The cutting tool of claim 5, wherein said knife blade extends past said proximal edge portion and is further attached along a length of said elongated shaft portion.

7. The cutting tool of claim 1, wherein said cutting tool is formed from a material chosen from a list of materials consisting of iron, steel, rolled steel, hardened steel, and ceramic.

8. A cutting tool assembly for use upon a cylindrical concrete form, comprising:
a hammer drill including:
a releasable attachment portion;
wherein said releasable attachment portion is adapted to releasably and securely hold a cutting tool;
wherein said hammer drill is adapted to provide repetitive linear movement to an attached cutting tool;
a cutting tool comprising:
an elongated shaft portion including;
a proximal end adapted to be releasably and securely held by said releasable attachment portion of said hammer drill;
a distal end opposite said proximal end; and
an axis extending between said proximal end and said distal end;
a slide plate;
wherein said slide plate is attached to said distal end of said elongated shaft portion;
wherein said slide plate has a curved cross-section adapted to be substantially similar to a cross-section of a chosen cylindrical concrete form;
an inner surface adapted to contact an outer surface of a cylindrical concrete column when in use; and
an outer surface adapted to contact an inner surface of said chosen cylindrical concrete form surrounding said cylindrical concrete column when in use; and
an elongated knife blade;
wherein said elongated knife blade is attached to said outer surface of said slide plate, and is oriented in a parallel direction to said axis of said elongated shaft portion;
wherein said cutting tool assembly is adapted to be used to cut said cylindrical
concrete form when in use such that said cylindrical concrete form can be peeled away from a formed concrete column.

9. The cutting tool of claim 8, wherein said elongated knife blade is attached to said outer surface of said slide plate at a 90 degree angle.

10. The cutting tool of claim 8, wherein said slide plate is attached to said distal end of said elongated shaft portion at an angle of between 5 degrees and 30 degrees.

11. The cutting tool of claim 8, wherein said slide plate includes a proximal edge portion attached to said distal end of said elongated shaft portion, and a beveled distal edge portion located opposite said proximal edge portion and adapted to wedge between said cylindrical concrete form and said formed concrete column when in use.

12. The cutting tool of claim 11, wherein said elongated knife blade has a length extending in a direction co-linear with said axis of said elongated shaft portion; wherein said knife blade extends from said beveled distal edge portion; and wherein said elongated knife blade has a height increasing along said length from said beveled distal edge portion to said proximal edge portion.

13. The cutting tool of claim 12, wherein said knife blade extends past said proximal edge portion and is further attached along a length of said elongated shaft portion.

14. The cutting tool of claim 8, wherein said cutting tool is formed from a material chosen from a list of materials consisting of iron, steel, rolled steel, hardened steel, and ceramic.

15. The cutting tool of claim 8, wherein said hammer drill is an electric hammer drill.

16. The cutting tool of claim 15, wherein said electric hammer drill is battery operated.
